(19) United States
(12) Patent Application Publication
(10) Pub. No.: US 2012/0222407 A1
(43) Pub. Date: Sep. 6, 2012

(54) CATALYST WARMING-UP CONTROLLER FOR INTERNAL COMBUSTION ENGINE

(75) Inventors: Makoto MIWA, Kariya-city (JP); Hiroyuki INUZUKA, Obu-city (JP)

(73) Assignee: DENSO CORPORATION, Kariya-city (JP)

(21) Appl. No.: 13/410,629

(22) Filed: Mar. 2, 2012

(30) Foreign Application Priority Data
Mar. 4, 2011 (JP) 2011-47108

(51) Int. Cl. F01N 3/00; F02D 41/30

(52) U.S. Cl. 60/284

(57) ABSTRACT

A catalyst warming-up controller executes a catalyst warming-up control in which an ignition timing is retarded to warm-up a catalyst and performs a compression-stroke injection in which a fuel is injected into a cylinder in a compression stroke. While the catalyst warming-up control is executed, a variable valve timing controller controls a valve timing of an intake valve and/or an exhaust valve to establish a negative-valve-overlap period in which both of the exhaust valve and the intake valve are closed. A fuel injector injects the fuel into a cylinder in this period and a quantity of the compression-stroke injection is decreasingly corrected according to the injection quantity in the above period.

### CROSS-REFERENCE TO RELATED APPLICATION

This application is based on Japanese Patent Application No. 2011-47108 filed on Mar. 4, 2011, the disclosure of which is incorporated herein by reference.

### TECHNICAL FIELD

The present disclosure relates to a catalyst warming-up controller for an internal combustion engine. In the internal combustion engine, a fuel is directly injected into a cylinder at least in a compression stroke while a catalyst warming-up control is executed.

### BACKGROUND

A catalyst, such as a three-way catalyst, is provided to an internal combustion engine of a vehicle so that exhaust gas is purified. Until the catalyst is warmed up to its active temperature after the engine is turned on, an exhaust gas purification rate of the catalyst is relatively low. Thus, after the engine is turned on, a catalyst warming-up control is executed to rapidly warm up the catalyst. In the catalyst warming-up control, as shown in JP-2010-25072A, an ignition timing is retarded to increase a temperature of the exhaust gas, whereby the warming-up of the catalyst is expedited.

While executing a catalyst warming-up control to retard an ignition timing in a direct injection engine, a fuel is injected into a cylinder in an intake stroke so as to form lean homogeneous air-fuel mixture and then the fuel is injected into the cylinder in a compression stroke to form a rich air-fuel mixture at a vicinity of a spark plug, whereby an ignitionability and a combustibility of the air-fuel mixture are improved. Since it is relatively short from when the fuel is injected in a compression stoke until when the injected fuel is ignited, if the injected fuel quantity in the compression stroke is excessive, it is likely that the air-fuel mixture is insufficiently atomized to be ignited. It may cause an increase in smoke and particulate matters (PM).

### SUMMARY

It is an object of the present disclosure to provide a catalyst warming-up controller for an internal combustion engine, which is capable of reducing amount of smoke and particulate matters while improving an ignitionability and a combustibility of an air-fuel mixture in a catalyst warming-up control.

A catalyst warming-up controller executes a catalyst warming-up control in which an ignition timing is retarded to warm-up a catalyst, and performs a compression-stroke injection in which a fuel is injected into a cylinder at least in a compression stroke. The catalyst warming-up controller includes an NVO-injection control portion which defines an negative-valve-overlap (NVO) period in which an exhaust valve and an intake valve are both closed at least in a posterior half of an exhaust stroke while the catalyst warming-up control is executed. The NVO-injection control portion performs an NVO-injection in which the fuel is injected into the cylinder in the negative-valve-overlap period. The catalyst warming-up controller further includes a correcting portion which corrects a fuel injection quantity in the compression stroke according to a fuel injection quantity of the NVO-injection.

During the NVO period, since a high temperature exhaust gas remaining in the cylinder (internal EGR gas) is compressed by a piston in the posterior half of the exhaust stroke, the temperature and pressure in the cylinder are increased. The fuel injected into the cylinder in the NVO period is exposed to high temperature and high pressure. Thus, a property of the fuel is improved, so that its ignitionability and combustibility are enhanced.

In view of the above, by injecting the fuel into the cylinder in the NVO period, the ignitionability and combustibility of the air-fuel mixture are enhanced even if the injection quantity in the compression stroke is reduced. The fuel injection quantity in the compression stroke can be reduced, whereby the exhaust amount of the smoke and particulate matters (PM) can be reduced. Thus, the amount of smoke and particulate matters can be reduced while the ignitionability and the combustibility of the air-fuel mixture are enhanced

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to a first embodiment of the present invention;

FIGS. 2A, 2B and 2C are charts for explaining a fuel injection control while a catalyst warming-up control is executed;

FIG. 3 is a flow chart showing a processing of a catalyst warming-up control according to the first embodiment;

FIG. 4 is a chart for explaining an advantage of the first embodiment; and

FIG. 5 is a flow chart showing a processing of a catalyst warming-up control according to a second embodiment.

### DETAILED DESCRIPTION

Embodiments of the present invention will be described, hereinafter.

### First Embodiment

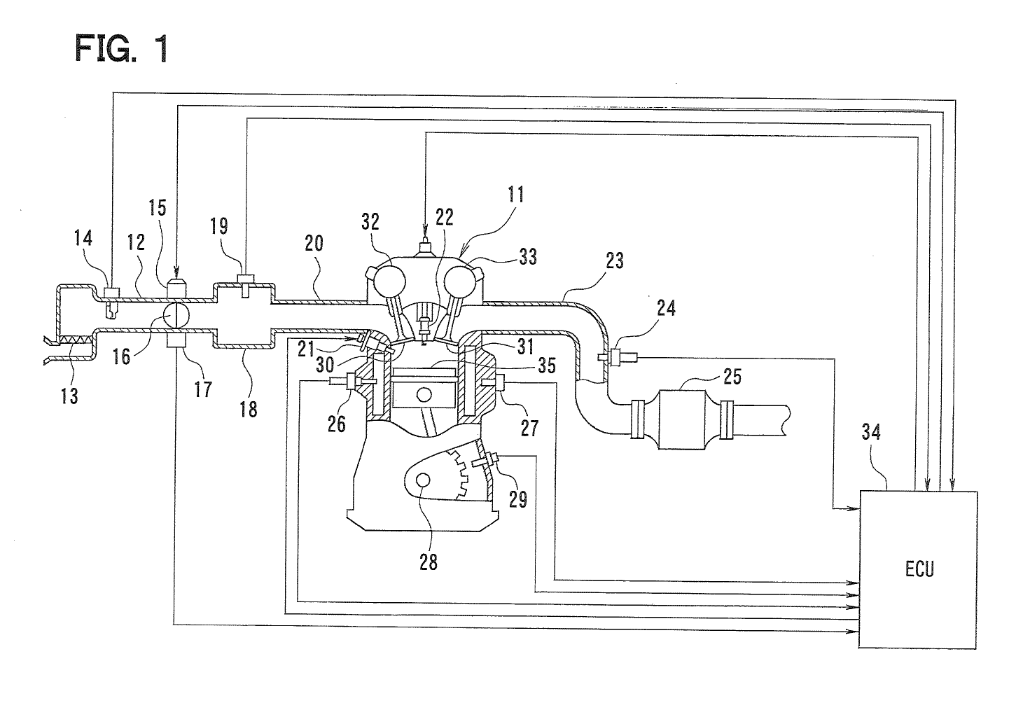

Referring to FIGS. 1 to 4, a first embodiment will be described hereinafter.

First, referring to FIG. 1, an engine control system is explained. An air cleaner 13 is arranged upstream of an intake pipe 12 of an internal combustion engine 11. An airflow meter 14 detecting an intake air flow rate is provided downstream of the air cleaner 13. A throttle valve 16 driven by a DC-motor 15 and a throttle position sensor 17 detecting a throttle position (throttle opening degree) are provided downstream of the air flow meter 14.

A surge tank 18 including an intake air pressure sensor 19 is provided downstream of the throttle valve 16. The intake air pressure sensor 19 detects intake air pressure. An intake manifold 20 is connected to the surge tank 18. A fuel injector 21 is mounted on each cylinder at a vicinity of an intake air port in order to inject fuel into the cylinder directly. A spark plug 22 is mounted on a cylinder head of the engine 11 corresponding to each cylinder to ignite air-fuel mixture in each cylinder.

The engine 11 is provided an intake-side variable valve timing controller 32 which adjusts a valve timing of an intake valve 30, and an exhaust-side variable valve timing controller 33 which adjusts a valve timing of an exhaust valve 31.

An exhaust gas sensor (an air fuel ratio sensor, an oxygen sensor, etc.) 24 which detects an air-fuel ratio of the exhaust gas is respectively provided in each exhaust pipe 23, and a three-way catalyst 25 which purifies the exhaust gas is provided downstream of the exhaust gas sensor 24.

A coolant temperature sensor 26 detecting a coolant temperature and a knock sensor 27 detecting knocking of the engine are disposed on a cylinder block of the engine 11. A crank angle sensor 29 is installed on a cylinder block to output crank angle pulses when a crank shaft 28 rotates a predetermined angle. Based on this crank angle pulses, a crank angle and an engine speed are detected.

The outputs of the above sensors are transmitted to an electronic control unit (ECU) 34. The ECU 34 includes a microcomputer which executes an engine control program stored in a Read Only Memory (ROM) to control a fuel injection quantity, an ignition timing, a throttle position (intake air flow rate) and the like.

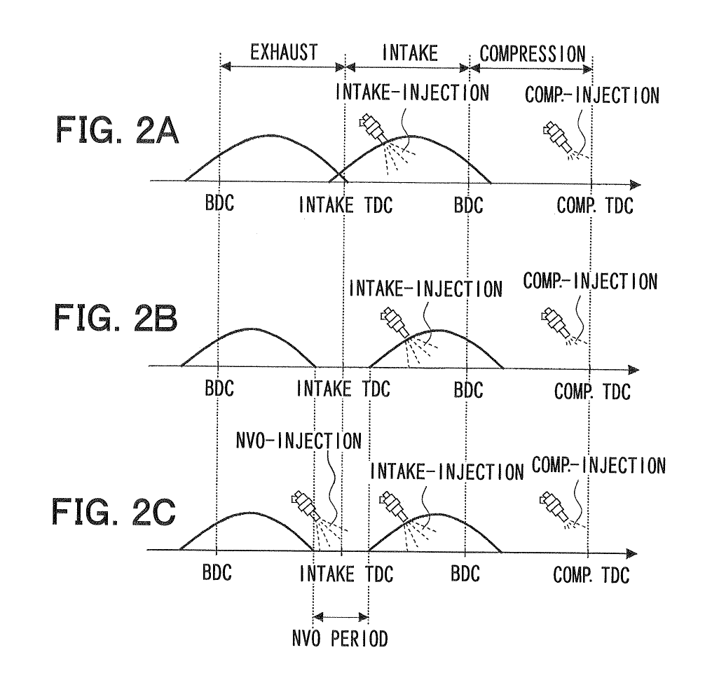

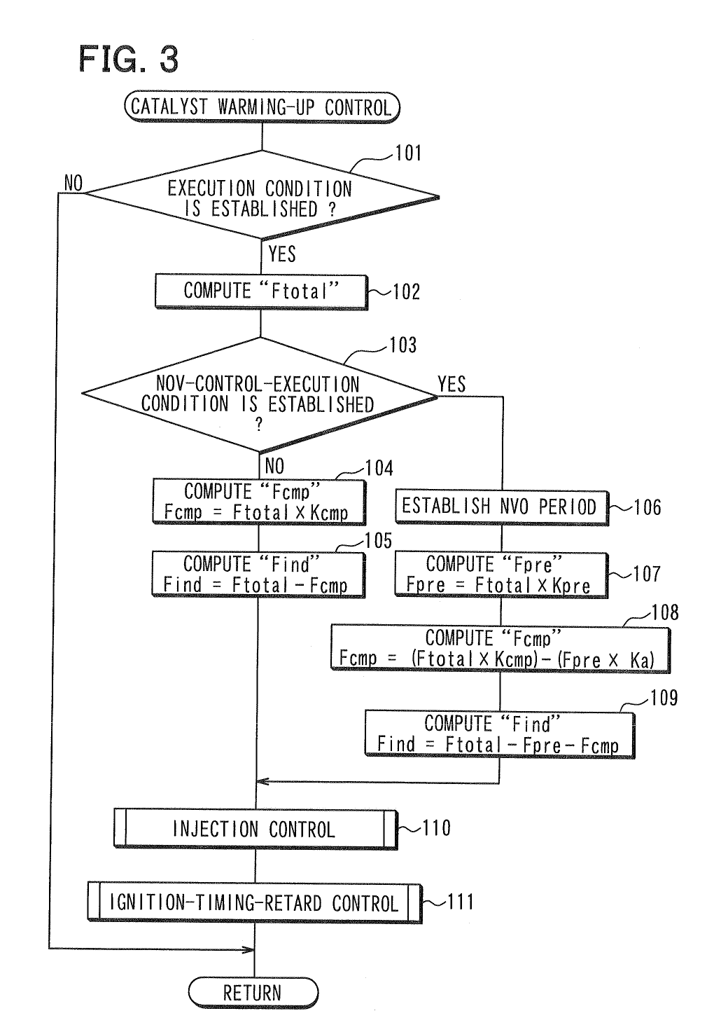

Also, the ECU 34 executes a catalyst warming-up control routine shown in FIG. 3. When a specified execution condition is satisfied, the ECU 34 retards the ignition timing to rapidly warm up the catalyst 25. As shown in FIG. 2A, while executing a catalyst warming-up control, the fuel injector 21 injects fuel into a cylinder in an intake stroke so as to form lean homogeneous air-fuel mixture (main injection). After that, the fuel injector 21 injects the fuel into the cylinder in a compression stroke to form a rich air-fuel mixture at a vicinity of a spark plug, whereby an ignitionability and a combustibility of the air-fuel mixture are improved.

However, since it is relatively short from when the fuel is injected in a compression stoke until when the injected fuel is ignited, if the injected fuel quantity in the compression stroke is excessive, it is likely that the air-fuel mixture is insufficiently atomized to be ignited. It may cause an increase in smoke and particulate matters (PM).

According to the present embodiment, while the catalyst warming-up control is executed, when a specified NVO-control-execution condition is established, as shown in FIG. 2B, the variable valve timing controllers 32, 33 control the valve timing of the intake valve 30 and the exhaust valve 31 to establish a negative-valve-overlap (NVO) period in which both of the exhaust valve 31 and the intake valve 30 is closed at least in a posterior half of the exhaust stroke. For example, the NVO period is established from a posterior half of an exhaust stroke to an anterior half of an intake stroke. The variable valve timing controller 33 controls the valve timing of the exhaust valve 31 so that the closing timing of the exhaust valve 31 is advanced relative to a top dead center (TDC). The variable valve timing controller 32 controls the valve timing of the intake valve 30 so that the opening timing of the intake valve 30 is retarded relative to the top dead center.

Then, as shown in FIG. 2C, an NVO-injection (pre-injection) is executed so that the fuel injector 21 injects the fuel into the cylinder in the NVO-period. Further, an injection-quantity reducing correction is executed, in which the fuel injection quantity in the compression stroke is reduced according to a fuel injection quantity of the NVO-injection. The fuel injection quantity of the NVO-injection is referred to as an NVO-injection quantity.

During the NVO period, since a high temperature exhaust gas remaining in the cylinder (internal EGR gas) is compressed by a piston 35 in the posterior half of the exhaust stroke, the temperature and pressure in the cylinder are increased. The fuel injected into the cylinder in the NVO period is exposed to high temperature and high pressure. Thus, a property of the fuel is improved, so that its ignitionability and combustibility are enhanced.

In view of the above, by injecting the fuel into the cylinder in the NVO period, the ignitionability and combustibility of the air-fuel mixture are enhanced even if the injection quantity in the compression stroke is reduced. The fuel injection quantity in the compression stroke can be reduced, whereby the exhaust amount of the smoke and particulate matters (PM) can be reduced.

Referring to FIG. 3, a processing of the catalyst warming-up control will be described hereinafter. The catalyst warming-up control is executed at specified intervals while the ECU 34 is ON (for example, while the ignition switch is on). In step 101, the computer determines whether a warming-up control executing condition is established based on whether a coolant temperature and an intake air temperature are lower than specified values.

When the answer is No in step 101, the routine is finished without performing the subsequent steps.

When the answer is Yes in step 101, the procedure proceeds to step 102. In step 102, the computer computes a required fuel injection quantity “Ftotal” based on a target air-fuel ratio in the catalyst warming-up control. The target air-fuel ratio may be a predetermined fixed value (for example, 15.5) or may be established according to the coolant temperature and the like.

Then, the procedure proceeds to step 103 in which the computer determines whether the NVO-control-execution condition is established based on whether a specified time period has elapsed after the catalyst warming-up control is started or whether an engine speed has become stable. If the NVO period is established before the engine speed becomes stable, it is likely that a variation in engine speed may become large due to an increase in internal EGR amount.

When the answer is NO in step 103, the procedure proceeds to step 104 in which the required fuel injection quantity “Ftotal” is multiplied by an injection ratio “Kcmp” to obtain a fuel injection quantity “Fcmp” in a compression stroke. The injection ratio “Kcmp” may be a predetermined fixed value or may be established according to the coolant temperature and the like.

Fcmp=Ftotal×Kcmp

Then, the procedure proceeds to step 105 in which the fuel injection quantity

“Fcmp” is subtracted from the required fuel injection quantity “Ftotal” to obtain a fuel injection quantity “Find” in an intake stroke.

Find=Ftotal−Fcmp

Then, the procedure proceeds to step 110 in which an intake-stroke injection (main injection) and a compression-stroke injection are performed. In the intake-stroke injection, the fuel of “Find” is injected in an intake stroke. In the compression-stroke injection, the fuel of “Fcmp” is injected in a compression stroke.

Then, the procedure proceeds to step 111 in which an ignition-timing-retard control is executed, whereby an ignition timing is retarded to a target ignition timing for the catalyst warming-up control. The target ignition timing for the catalyst warming-up control may be a predetermined fixed value (for example, ATDC 10° CA) or may be established according to the coolant temperature and the like.

When the answer is YES in step 103, the procedure proceeds to step 106 in which the variable valve timing controllers 32, 33 control the valve timing of the intake valve 30 and the exhaust valve 31 to establish the negative-valve-overlap (NVO) period.

Then, the procedure proceeds to step 107 in which the required fuel injection quantity “Ftotal” is multiplied by an NVO injection ratio “Kpre (for example, 0.2-0.3)” to obtain a fuel injection quantity “Fpre” of the NVO-injection. The NVO injection ratio “Kpre” is defined based on an exhaust gas temperature and an NVO quantity. Generally, as the exhaust gas temperature is higher, a heat energy for improving a property of the fuel is more increased. As the NVO quantity is larger, the heat energy for improving the property of the fuel is more increased. Thus, as the exhaust gas temperature is higher, the ratio “Kpre” is set larger. As the NVO quantity is greater, the ratio “Kpre” is set larger.

Fpre=Ftotal×Kpre

Then, the procedure proceeds to step 108 in which the NVO-injection quantity “Fpre” is multiplied by a reduction correction coefficient “Ka” (Ka>1) to obtain a reduction correction quantity “Fpre×Ka”. The reduction correction quantity “Fpre×Ka” is subtracted from a based fuel injection quantity “Ftotal×Kcmp”, whereby the compression-stroke injection quantity “Fcmp” is corrected according to the NVO-injection quantity “Fpre”.

Fcmp=(Ftotal×Kcmp)−(Fpre×Ka)

In this case, as the NVO-injection quantity “Fpre” is greater, the reduction correction quantity “Fpre×Ka” is greater. Thereby, as the NVO-injection quantity “Fpre” is greater, the quantity of fuel of which property is improved is increased and the compression-stroke injection quantity “Fcmp” is reduced.

If a combustibility in the engine 11 is deteriorated, the reduction correction quantity “Fpre×Ka” is guarded by an upper guard value or the coefficient “Ka” is made smaller so that the reduction correction quantity “Fpre×Ka” is made smaller. Thus, even if the combustibility in the engine 11 is deteriorated due to variations in engine performance and fuel property, the reduction correction quantity “Fpre×Ka” is guarded or decreased, whereby a deterioration in combustibility is restricted.

Then, the procedure proceeds to step 109 in which the NOV-injection quantity “Fpre” and the compression-stroke injection quantity “Fcmp” are subtracted from the required fuel injection quantity “Ftotal” so as to obtain the intake-stroke injection quantity “Find”.

Find=Ftotal−Fpre−Fcmp

Then, the procedure proceeds to step 110 in which the NOV-injection (pre-injection), the intake-stroke injection (main-injection) and the compression-stroke injection are performed. Then, the procedure proceeds to step 111 in which the ignition-timing-retard control is executed.

In the present embodiment, the processes in steps 106, 107, 110 correspond to an NVO-injection control portion, and the processes in steps 108, 110 correspond to a correcting portion of compression-stroke injection quantity.

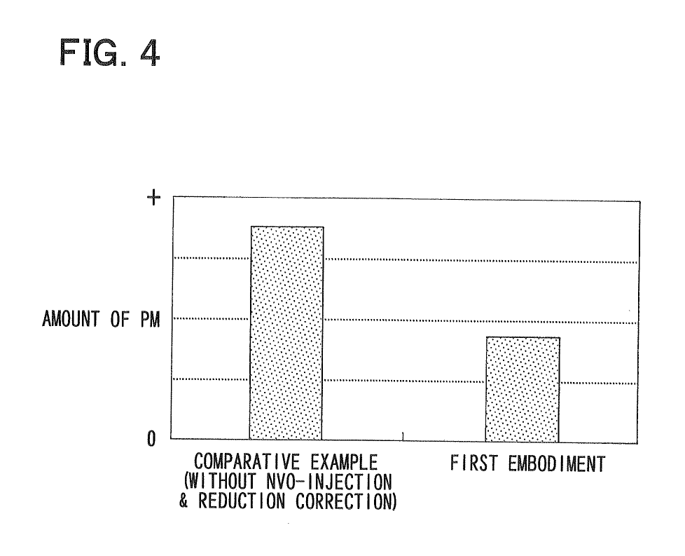

According to the present embodiment, since the compression-stroke injection quantity is reduced according to the NOV-injection quantity, the amount of smoke and particulate matters can be reduced while the ignitionability and the combustibility of the air-fuel mixture are enhanced, as shown in FIG. 4.

### Second Embodiment

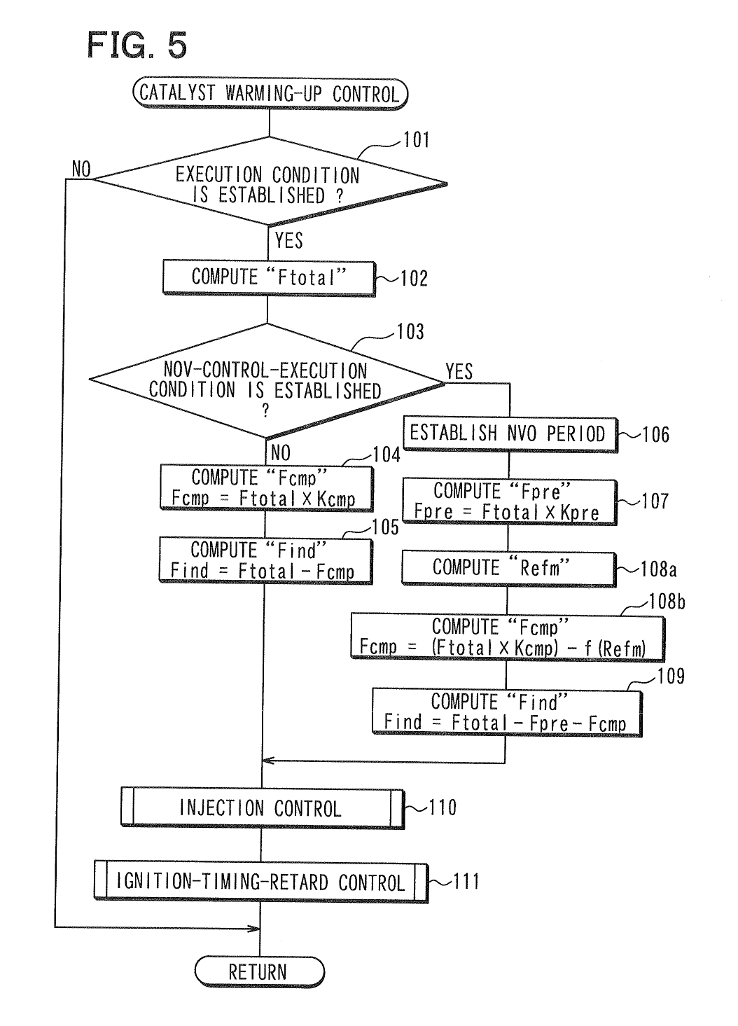

Referring to FIG. 5, a second embodiment will be described hereinafter. In the second embodiment, the same parts and components as those in the first embodiment are indicated with the same reference numerals and the same descriptions will not be reiterated.

According to the second embodiment, the ECU 34 executes a catalyst warming-up control routine shown in FIG. 5. While the catalyst warming-up control is executed, the fuel injector 21 injects the fuel into a cylinder in the NVO period. The property of the injected fuel is improved. This fuel property improvement is detected and the compression-stroke injection quantity is decreasingly corrected according to the fuel property improvement.

The process in step 108 in FIG. 3 is replaced by processes in steps 108a and 108b in FIG. 5. The other steps in FIG. 5 are the same as those in FIG. 3.

When the answer is YES in step 103, the procedure proceeds to step 106 in which the NOV-period is established. In step S107, the required fuel injection quantity “Ftotal” is multiplied by the ratio “Kpre” to obtain the NVO-injection quantity “Fpre”.

Then, the procedure proceeds to step 108a in which the computed detects an improvement degree “Refm” of the fuel injected into a cylinder in the NVO period. Specifically, the ion current which is generated according to the improvement degree of the fuel injected in the NVO period is detected through the electrodes of the spark plug 21. An integrated value of the ion current, its peak value, its variation speed and the like are used as an information indicating the improvement degree of the fuel. In this case, the spark plug 22, an ion current detecting circuit and the like function as a fuel-improvement-degree detecting portion.

In a case that the fuel injection system is provided with a combustion pressure sensor detecting a combustion pressure in a cylinder, an integrated value, a peak value, and a variation speed of combustion pressure can be used as the information indicating the improvement degree of the fuel. In this case, the combustion pressure sensor corresponds to a fuel-improvement-degree detecting portion.

Then, the procedure proceeds to step 108b in which a reduction correction quantity f(Refm) is computed according to a map or a formula. The reduction correction quantity f(Refm) is subtracted from the base fuel injection quantity “Ftotal×Kcmp”, whereby the compression-stroke injection quantity “Fcmp” is corrected according to the improvement degree “Refm” of the fuel.

Fcmp=(Ftotal×Kcmp)−f(Refm)

In the above map or a formula of the reduction correction quantity f(Refm), as the improvement degree “Refm” is greater, the reduction correction quantity f(Refm) is established greater. Thereby, as the improvement degree “Refm” is greater, the compression-stroke injection quantity “Fcmp” is reduced and the reduction correction quantity f(Refm) is increased.

If the combustibility in the engine 11 is deteriorated, the reduction correction quantity f(Refm) is guarded by an upper guard value. Thus, even if the combustibility in the engine 11 is deteriorated due to variations in engine performance and fuel property, the reduction correction quantity f(Refm) is guarded, whereby a deterioration in combustibility is restricted.

Then, the procedure proceeds to step 109 in which the NOV-injection quantity “Fpre” and the compression-stroke injection quantity “Fcmp” are subtracted from the required fuel injection quantity “Ftotal” so as to obtain the intake-stroke injection quantity “Find”.

Find=Ftotal−Fpre−Fcmp

Then, the procedure proceeds to step 110 in which the NOV-injection (pre-injection), the intake-stroke injection (main-injection) and the compression-stroke injection are performed. Then, the procedure proceeds to step 111 in which the ignition-timing-retard control is executed.

According to the second embodiment, the fuel property improvement is detected and the compression-stroke injection quantity is decreasingly corrected according to the fuel property improvement. The fuel property improvement represents an improved fuel quantity or an improvement progress degree of the fuel. Thus, the amount of smoke and particulate matters can be reduced while the ignitionability and the combustibility of the air-fuel mixture are enhanced. Furthermore, since the fuel property improvement is actually detected, the compression-stroke injection quantity can be accurately corrected.

In the above embodiments, the valve timing controllers 32, 33 are employed to establish the NVO period. However, instead of the valve timing controllers 32, 33, variable valve lift controllers can be employed to establish the NVO period. The variable valve lift controller controls the valve lift of the exhaust valve 31 so that the closing timing of the exhaust valve 31 is advanced relative to a top dead center (TDC). Another variable valve lift controller controls the valve lift of the intake valve 30 so that the opening timing of the intake valve 30 is retarded relative to the top dead center.

The NVO period can be established by operating one of the valve timing controllers 32, 33 or one of the valve lift controllers.

The present invention is not limited to a direct injection engine. The present invention can be applied to a dual injection engine.

What is claimed is:

1. A catalyst warming-up controller for an internal combustion engine, which executes a catalyst warming-up control in which an ignition timing is retarded to warm-up a catalyst and which performs a compression-stroke injection in which a fuel is injected into a cylinder at least in a compression stroke, the catalyst warming-up controller comprising:
an NVO-injection control portion which defines a negative-valve-overlap period in which an exhaust valve and an intake valve are both closed at least in a posterior half of an exhaust stroke while the catalyst warming-up control is executed, the NVO-injection control portion which performs an NVO-injection in which the fuel is injected into the cylinder in the negative-valve-overlap period; and
a correcting portion which corrects a fuel injection quantity in the compression stroke according to a fuel injection quantity of the NVO-injection.

2. A catalyst warming-up controller for an internal combustion engine according to claim 1, wherein
the correcting portion increases a reduction correction quantity of the fuel injection quantity in the compression stroke as the fuel injection quantity of the NVO-period is larger.

3. A catalyst warming-up controller for an internal combustion engine according to claim 1, wherein
when a combustibility of an air-fuel mixture in a cylinder is deteriorated, the correcting portion restricts or reduces the reduction correction quantity of the fuel injection quantity in the compression stroke.

4. A catalyst warming-up controller for an internal combustion engine according to claim 1, further comprising:
a fuel-improvement-degree detecting portion which detects an improvement degree of the fuel which has been injected into the cylinder in the negative-valve-overlap period, wherein
the correcting portion corrects the fuel injection quantity in the compression stroke according to the fuel injection quantity of the NVO-injection and the improvement degree of the fuel.

5. A catalyst warming-up controller for an internal combustion engine, which executes a catalyst warming-up control in which an ignition timing is retarded to warm-up a catalyst and which performs a compression-stroke injection in which a fuel is injected into a cylinder at least in a compression stroke, the catalyst warming-up controller comprising:
an NVO-injection control portion which defines a negative-valve-overlap period in which an exhaust valve and an intake valve are both closed at least in a posterior half of an exhaust stroke while the catalyst warming-up control is executed, the NVO-injection control portion which performs an NVO injection in which the fuel is injected into the cylinder in the negative-valve-overlap period;
a fuel-improvement-degree detecting portion which detects an improvement degree of the fuel which has been injected into the cylinder in the negative-valve-overlap period; and
a correcting portion which corrects a fuel injection quantity in the compression stroke according to the improvement degree of the fuel detected by the fuel-improvement-degree detecting portion.

6. A catalyst warming-up controller for an internal combustion engine according to claim 5, wherein
the correcting portion increases a reduction correction quantity of the fuel injection quantity in the compression stroke as the improvement degree of the fuel is greater.

7. A catalyst warming-up controller for an internal combustion engine according to claim 5, wherein
when a combustibility of an air-fuel mixture in a cylinder is deteriorated, the correcting portion restricts or reduces the reduction correction quantity of the fuel injection quantity in the compression stroke.

8. A catalyst warming-up controller for an internal combustion engine according to claim 5, wherein
the improvement degree of the fuel corresponds to an improved fuel quantity.

9. A catalyst warming-up controller for an internal combustion engine according to claim 5, wherein
the improvement degree of the fuel corresponds to an improvement progress degree of the fuel.
